(19) United States
(12) Patent Application Publication
(10) Pub. No.: US 2011/0069480 A1
(43) Pub. Date: Mar. 24, 2011

(54) ILLUMINATION STRUCTURE OF SWITCH PANEL

(76) Inventor: Hsiu-Ling Yang, Tauyuan City (TW)

(21) Appl. No.: 12/878,286

(22) Filed: Sep. 9, 2010

(30) Foreign Application Priority Data
Sep. 22, 2009 (TW) 098217483

(51) Int. Cl. F21L 4/08; H05B 37/02

(52) U.S. Cl. 362/183; 315/294

(57) ABSTRACT

An illumination structure of a switch panel includes a panel, at least one edge of the panel being provided with a receptacle, a conductive section being disposed in the receptacle and connected to an AC/DC conversion module; and an illumination mechanism detachably received in the receptacle. The illumination mechanism has a first and a second light-emitting sections and an illumination control module connected to the first and second light-emitting sections. The illumination control module is electrically connected to the AC/DC conversion module via contacts and the conductive section. The illumination mechanism further has a switch section connected to the first and second light-emitting sections and the illumination control module. The illumination mechanism can be securely located in the receptacle of the panel or easily taken off from the panel as a flashlight. The appearance and the size of the panel will not be changed due to the illumination mechanism.

### CROSS-REFERENCE TO RELATED APPLICATION

This non-provisional application claims priority under 35 U.S.C. § 119(a) on Patent Application No(s) .098217483 filed in Taiwan, R.O.C. on Sep. 22, 2009, the entire contents of which are hereby incorporated by reference.

### FIELD OF THE INVENTION

The present invention relates to an improved illumination structure of a switch panel. The illumination structure includes a panel and an illumination mechanism detachably received in a receptacle of the panel. The illumination mechanism can be securely located in the receptacle of the panel or easily taken off from the panel as a flashlight. The appearance and the size of the panel will remain unchanged and tidy without being affected by the illumination mechanism. The illumination structure can provide nighttime illumination, emergency illumination and mobile illumination effect.

### BACKGROUND OF THE INVENTION

A conventional switch panel with illumination structure includes a panel and an illumination mechanism detachably disposed on the panel. An edge of the panel is formed with an insertion channel. At least one lateral side of the illumination mechanism is provided with a guide block, which is slidably inserted in the insertion channel. Accordingly, the illumination mechanism can be mounted on the panel as a night lamp or taken off from the panel and solely used as a flashlight.

The guide block of the illumination mechanism is slidably inserted in the insertion channel of the panel. The insertion channel has a considerable length so that it takes time to move the illumination mechanism out of the panel. Therefore, a user cannot readily use the illumination mechanism. Moreover, in the case that the guide block is not properly assembled with the insertion channel, the guide block will be dislocated and derailed. Under such circumstance, it is impossible to securely associate the illumination mechanism with the panel and the user can hardly conveniently use the illumination mechanism.

In another conventional switch panel with illumination structure, a first attraction section (magnet or metal plate) is arranged on an edge of the panel and a second attraction section (metal plate or magnet) is arranged on one face of the illumination mechanism. The first and second attraction sections can attract each other to easily detachably assemble the illumination mechanism with the panel.

Such measure can overcome the shortcomings existing in the conventional switch panel with the insertion channel and guide block. However, in both the above conventional switch panels, the illumination mechanisms are added to the edges of the panels. The additional illumination mechanism will deteriorate the appearance of the panel and enlarge the size of the panel.

It is therefore tried by the applicant to provide an improved illumination structure of a switch panel. The illumination structure includes a panel and an illumination mechanism detachably received in a receptacle of the panel. The illumination mechanism can be securely located in the receptacle of the panel or easily taken off from the panel as a flashlight. The appearance and the size of the panel will remain unchanged and tidy without being affected by the illumination mechanism. The illumination structure can provide nighttime illumination, emergency illumination and mobile illumination effect.

### SUMMARY OF THE INVENTION

A primary object of the present invention is to provide an improved illumination structure of a switch panel. The illumination structure includes a panel and an illumination mechanism. The panel is provided with a receptacle in which the illumination mechanism is detachably received. Accordingly, the illumination mechanism can be securely located in the receptacle of the panel or easily taken off from the panel as a flashlight. The appearance and the size of the panel will remain unchanged and tidy without being affected by the illumination mechanism. The illumination structure can provide nighttime illumination, emergency illumination and mobile illumination effect.

According to the above and other objects, the illumination structure of the switch panel of the present invention includes: a panel, an edge of the panel being provided with a receptacle, a conductive section being disposed in the receptacle and connected to an AC/DC conversion module; and an illumination mechanism detachably received in the receptacle. The illumination mechanism has a first light-emitting section and a second light-emitting section and an illumination control module connected to the first and second light-emitting sections. The illumination control module is electrically connected to the AC/DC conversion module via contacts and the conductive section. The illumination mechanism further has a switch section connected to the first and second light-emitting sections and the illumination control module.

The illumination mechanism can be securely located in the receptacle of the panel or easily taken off from the panel as a flashlight. The appearance and the size of the panel will not be changed due to the illumination mechanism. The illumination structure can provide nighttime illumination, emergency illumination and mobile illumination effect.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of the present invention;

FIG. 2 is a perspective assembled view of the present invention;

FIG. 3 is a block diagram of the AC/DC conversion module and the illumination control module of the present invention;

FIG. 4 is a block diagram of the present invention in an assembled state;

FIG. 5 is a sectional view of the present invention; and

FIG. 6 shows the use of the present invention in flashlight mode.

### DETAILED DESCRIPTION OF THE PREFERRED EMBODIMENTS

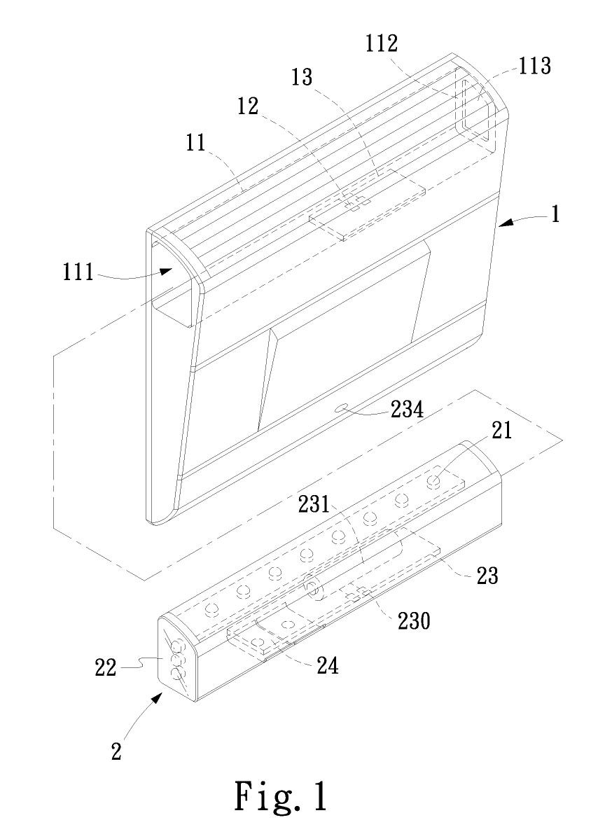

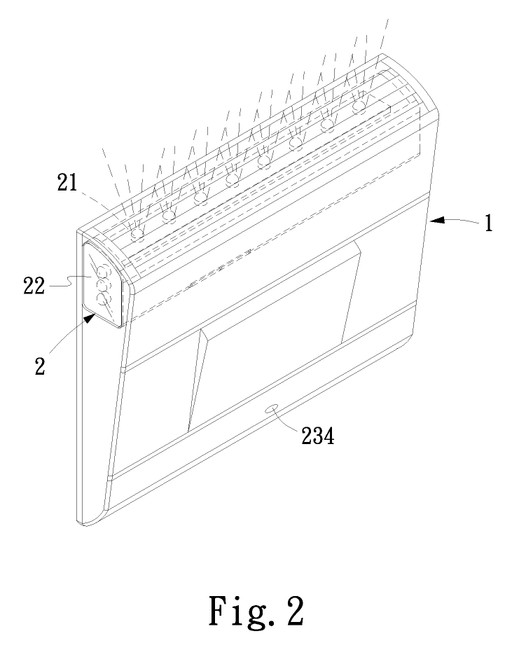

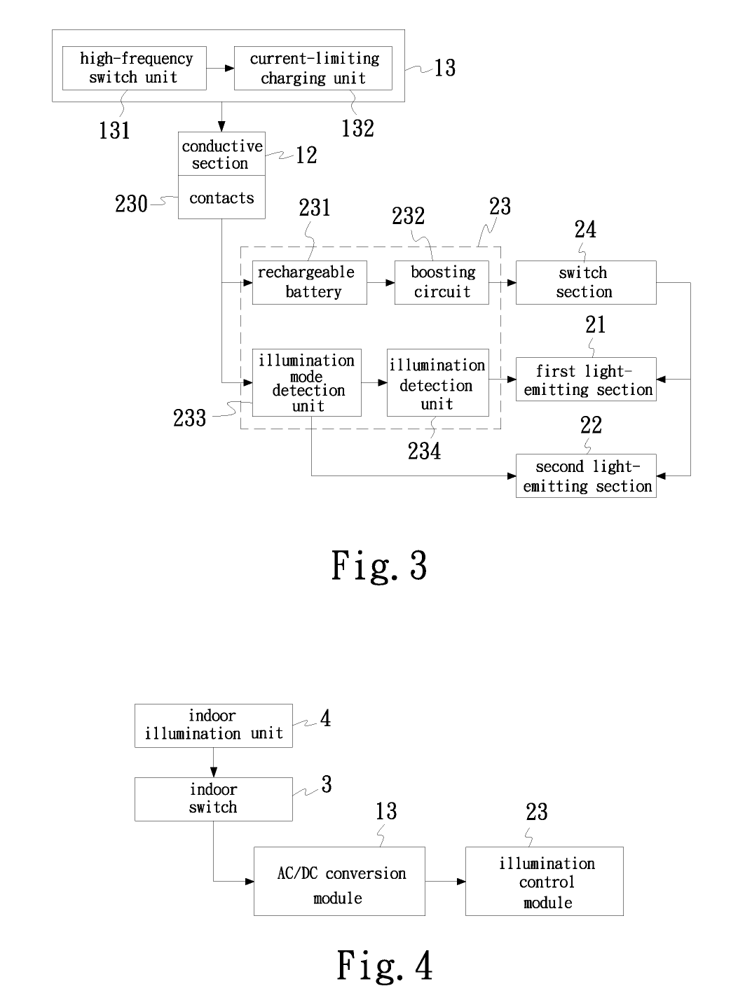

Please refer to FIGS. 1, 2 and 3, in which FIG. 1 is a perspective exploded view of the present invention, FIG. 2 is a perspective assembled view of the present invention, and FIG. 3 is a block diagram of the AC/DC conversion module and the illumination control module of the present invention. The illumination structure of the switch panel of the present invention at least includes a panel 1 and an illumination mechanism 2.

At least one edge of the panel 1 is provided with a receptacle 11. A first end of the receptacle 11 is formed with an opening 111, while a second end of the receptacle 11 is formed with a stop section 112. A through hole 113 is formed at a center of the stop section 112. A conductive section 12 is disposed in the receptacle 11 and connected to an AC/DC conversion module 13, which is connectable to an external power supply. The AC/DC conversion module 13 at least includes a high-frequency switch unit 131 and a current-limiting charging unit 132, which are electrically connected to each other.

The illumination mechanism 2 is received in the receptacle 11. The illumination mechanism 2 has a first light-emitting section 21 and a second light-emitting section 22. The first light-emitting section 21 can be arranged on a lateral side of the illumination mechanism 2, while the second light-emitting section 22 can be arranged at one end of the illumination mechanism 2. The illumination mechanism 2 further has an illumination control module 23 connected to the first and second light-emitting sections 21, 22. The illumination control module 23 is electrically connected to the AC/DC conversion module 13 via contacts 230 and the conductive section 12. The illumination control module 23 at least includes a rechargeable battery 231, a boosting circuit 232, an illumination mode detection unit 233 and an illumination detection unit 234, which are electrically connected to each other. The illumination detection unit 234 can be arranged on an outer face of the panel 1. In addition, the illumination mechanism 2 further has a switch section 24 connected to the first and second light-emitting sections 21, 22 and the illumination control module 23.

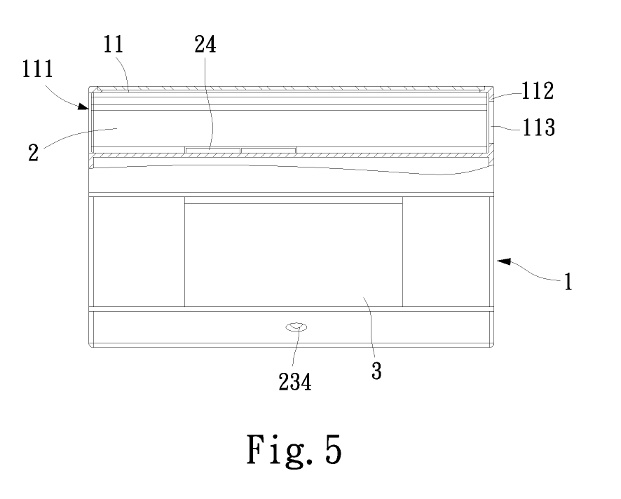

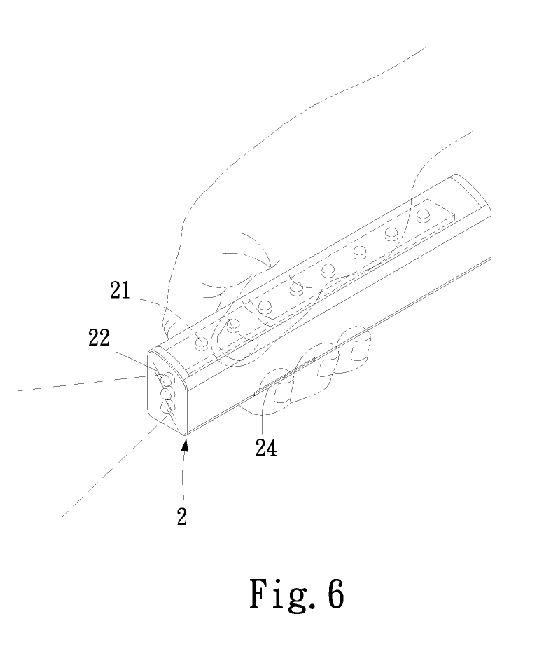

Please refer to FIGS. 4, 5 and 6, in which FIG. 4 is a block diagram of the present invention in an assembled state, FIG. 5 is a sectional view of the present invention, and FIG. 6 shows the use of the present invention in flashlight mode. As shown in FIGS. 4 to 6 as well as FIGS. 1 to 3, the panel 1 of the present invention can be mounted on an outer side of a common indoor switch 3 (or power socket) in substitution for the original switch panel. The illumination mechanism 2 is received in the receptacle 11 of the edge of the panel 1 so that the appearance and the size of the panel 1 will remain unchanged and tidy without being affected by the illumination mechanism 2. In the original indoor switch 3, the power distribution circuit is only provided with a live wire (as the positive electrode) and inadaptable to the AC/DC conversion module 13, the illumination mechanism 2 and the illumination control module 23 for charging. Therefore, in use of the present invention, a grounding wire is added to the power distribution circuit of the indoor switch 3 as the negative electrode to provide a negative electrode circuit between the indoor switch 3 and an indoor illumination unit 4. Under such circumstance, after the illumination mechanism 2 is connected to the power supply of the indoor switch 3 via the conductive section 12 and the AC/DC conversion module 13, in the case that the indoor illumination unit 4 is turned off via the indoor switch 3, a negative electrode circuit is formed for charging the illumination mechanism 2.

When the illumination mechanism 2 is used in connection with the panel 1, the illumination mechanism 2 is directly placed into the receptacle 11 from the opening 111. The stop section 112 of the second end of the receptacle 11 serves to prevent the illumination mechanism 2 from dropping out of the receptacle and keep the illumination mechanism 2 securely associated with the panel 1. Also, the contacts 230 of the illumination control module 23 are in contact with the conductive section 12 (as shown in FIG. 5) to electrically connect the illumination control module 23 with the AC/DC conversion module 13. The AC/DC conversion module 13 not only supplies necessary power for the illumination mechanism 2, but also charges the rechargeable battery 231 of the illumination mechanism 2. When charged, the high-frequency switch unit 131 converts AC high voltage into DC low voltage at high efficiency. The current-limiting charging unit 132 cooperates with the high-frequency switch unit 131 to protect the rechargeable battery 231. The rechargeable battery 231 has a lower voltage itself. Therefore, in use, the voltage is boosted with the boosting circuit 232 for driving the first and second light-emitting sections 21, 22.

After the illumination mechanism 2 is connected with the panel 1, the illumination detection unit 234 of the illumination control module 23 serves to detect the ambient light source. In the case of darkness or blackout, the first light-emitting section 21 is turned on to provide illumination as a night lamp or emergency light (as shown in FIG. 2). Reversely, when the illumination is sufficient, the illumination detection unit 234 turns off the first light-emitting section 21 and the rechargeable battery 231 is charged. In the case of blackout, the first light-emitting section 21 will emit light as an emergency light for a user to locate the illumination mechanism 2. Then the user can apply a force to the other end (the bottom section) of the illumination mechanism 2 through the through hole 113 of the stop section 112 so as to extrude the illumination mechanism 2 out of the opening 111 and detach the illumination mechanism 2 from the receptacle 11. Accordingly, the illumination mechanism 2 can be easily taken off from the panel 1. When the illumination control module 23 is removed from the AC/DC conversion module 13, the illumination mode detection unit 233 will switch the illumination mechanism 2 to a flashlight mode. At this time, the user only needs to switch on the switch section 24, whereby the rechargeable battery 231 will supply power to turn on the second light-emitting section 22 as a flashlight (as shown in FIG. 6). After used, the user only needs to replace the illumination mechanism 2 through the opening 111 into the receptacle 11 and securely locate the illumination mechanism 2 in the panel 1. When the illumination control module 23 is connected to the AC/DC conversion module 13, the illumination mode detection unit 233 will switch the illumination mechanism 2 to a night lamp mode. No matter whether the illumination mechanism 2 is used in the night lamp mode or the flashlight mode, the first and second light-emitting sections 21, 22 can be turned on or off by means of the switch section 24 in cooperation with the rechargeable battery 231.

In conclusion, the illumination mechanism can be securely located in the receptacle of the panel or easily taken off from the panel to serve as a flashlight. The illumination mechanism is received in the receptacle of the panel so that the appearance and the size of the panel will remain unchanged and tidy without being affected by the illumination mechanism. The present invention can provide nighttime illumination, emergency illumination and mobile illumination effect to fully satisfy the current demands on the market.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

What is claimed is:

1. An illumination structure of a switch panel, comprising:
a panel, at least one edge of the panel being provided with a receptacle, a conductive section being disposed in the receptacle and connected to an AC/DC conversion module, the AC/DC conversion module being connectable to an external power supply; and
an illumination mechanism detachably received in the receptacle, the illumination mechanism having a first light-emitting section and a second light-emitting section, the illumination mechanism further having an illumination control module connected to the first and second light-emitting sections, the illumination control module being electrically connected to the AC/DC conversion module via contacts and the conductive section, the illumination mechanism further having a switch section connected to the first and second light-emitting sections and the illumination control module.

2. The illumination structure of the switch panel as claimed in claim 1, wherein a first end of the receptacle is formed with an opening, while a second end of the receptacle is formed with a stop section, a through hole being formed at a center of the stop section.

3. The illumination structure of the switch panel as claimed in claim 1, wherein the AC/DC conversion module at least includes a high-frequency switch unit and a current-limiting charging unit, which are electrically connected to each other.

4. The illumination structure of the switch panel as claimed in claim 1, wherein the first light-emitting section is arranged on a lateral side of the illumination mechanism, while the second light-emitting section is arranged at one end of the illumination mechanism.

5. The illumination structure of the switch panel as claimed in claim 1, wherein the illumination control module at least includes a rechargeable battery, a boosting circuit, an illumination mode detection unit and an illumination detection unit, which are electrically connected to each other, the illumination detection unit being arranged on an outer face of the panel.
